(19) United States
(12) Patent Application Publication
(10) Pub. No.: US 2023/0398703 A1
(43) Pub. Date: Dec. 14, 2023

(54) DEVICE AND APPARATUS INCLUDING THE SAME

(71) Applicants: Hyundai Motor Company, Seoul (KR); Kia Corporation, Seoul (KR)

(72) Inventors: Min Woong Jeung, Seoul (KR); Ki Hyeon Bae, Hwaseong-si (KR); Ju Young Yoon, Suwon-si (KR); Kyu Jung Kim, Seoul (KR); Hyo Joong Kim, Suwon-si (KR); Seong Taek Hwang, Suwon-si (KR); Ho Jun Kim, Gunpo-si (KR); Hyun Seop Lim, Anyang-si (KR); Beom Su Kim, Yongin-si (KR)

(21) Appl. No.: 17/984,858

(22) Filed: Nov. 10, 2022

(30) Foreign Application Priority Data
Jun. 10, 2022 (KR) 10-2022-0070932

(51) Int. Cl. B25J 17/00; B25J 9/00; A61H 3/00

(52) U.S. Cl. CPC B25J 17/00; B25J 9/0006; A61H 3/00; A61H 2201/165; A61H 2003/007

(57) ABSTRACT

Disclosed is a device including a first connection link coupled to be rotatable about a first rotary shaft, a second connection link coupled to be rotatable relative to the first connection link about a second rotary shaft, a third connection link coupled to be rotatable relative to the second connection link about a third rotary shaft, and a fourth connection link coupled to be rotatable relative to the third connection link about a fourth rotary shaft, in which first to fourth extension axes respectively defined by extending the first to fourth rotary shafts in longitudinal directions thereof intersect in an intersection region.

### CROSS-REFERENCE TO RELATED APPLICATIONS

This application claims priority to and the benefit of Korean Patent Application No. 10-2022-0070932 filed in the Korean Intellectual Property Office on Jun. 10, 2022, the entire contents of which are incorporated herein by reference.

### TECHNICAL FIELD

The present disclosure relates to a device for joint structure and an apparatus for exoskeleton robot including the same.

### BACKGROUND

As a type of exoskeleton robot that is worn on a body of a person and provides assistive power to the person, there is an exoskeleton robot that provides assistive power to a human knee joint. The exoskeleton robot is mounted on a periphery of a human knee and operates while assisting in providing a part of a rotational force required for a motion of the knee joint when the human knee joint moves.

Meanwhile, in the related art, as the exoskeleton robot configured to provide assistive power to the human knee joint, there have been applied i) a first type of exoskeleton robot in which a motor configured to provide assistive power to a knee is disposed at a lateral side of the knee, ii) a second type of exoskeleton robot in which a motor is disposed at a lateral side of a human thigh and a gear is connected to a rotary shaft of the motor, and iii) a third type of exoskeleton robot in which a predetermined linkage structure including a link is connected to a motor.

However, in the case of i) the first type of exoskeleton robot, the motor configured to generate a rotational force is disposed at the periphery of the human knee, and the motor is spaced apart from a human hip joint. For this reason, there is a problem in that a large load is applied to the human hip joint because of a weight of the motor when the person moves. In the case of ii) the second type of exoskeleton robot, there is a problem in that backlash is caused by the gear structure, and wearing comfort deteriorates. In the case of iii) the third type of exoskeleton robot, there is a problem in that the exoskeleton robot has a complicated structure and a large volume because of the linkage structure.

### SUMMARY

The present disclosure relates to a device and an apparatus including the same, and more particularly, to a device capable of providing assistive power to a human joint motion, and an apparatus including the same.

The present disclosure has been made in an effort to provide a knee-assisting apparatus, in which a new type of device capable of being applied to the apparatus 1s applied, thereby reducing a load applied to a person who wears the apparatus, improving wearing comfort, and implementing a compact structure.

Embodiments provide a device including: a power generating member configured to rotate a first rotary shaft A1; a first connection link coupled to be rotatable about the first rotary shaft A1; a second connection link coupled to be rotatable relative to the first connection link about a second rotary shaft A2 spaced apart from the first rotary shaft A1; a third connection link coupled to be rotatable relative to the second connection link about a third rotary shaft A3 spaced apart from the second rotary shaft A2; and a fourth connection link coupled to be rotatable relative to the third connection link about a fourth rotary shaft A4 spaced apart from the third rotary shaft A3, in which a first extension axis L1 defined by extending the first rotary shaft A1 in a longitudinal direction thereof, a second extension axis L2 defined by extending the second rotary shaft A2 in a longitudinal direction thereof, a third extension axis L3 defined by extending the third rotary shaft A3 in a longitudinal direction thereof, and a fourth extension axis L4 defined by extending the fourth rotary shaft A4 in a longitudinal direction thereof intersect in one region (hereinafter, referred to as an ‘intersection region’).

The second rotary shaft A2 may be provided above the intersection region when the device is disposed so that the first rotary shaft A1 and the first extension axis L1 are provided in parallel with a vertical direction and the first rotary shaft A1 is positioned above the intersection region.

The third rotary shaft A3 may be provided above the intersection region when the device is disposed so that the first rotary shaft A1 and the first extension axis L1 are provided in parallel with a vertical direction and the first rotary shaft A1 is positioned above the intersection region.

[soon] The second rotary shaft A2 may be provided above the third rotary shaft A3 when the device is disposed so that the first rotary shaft A1 and the first extension axis L1 are provided in parallel with a vertical direction and the first rotary shaft A1 is positioned above the intersection region.

The fourth rotary shaft A4 may be provided below the intersection region when the device is disposed so that the first rotary shaft A1 and the first extension axis L1 are provided in parallel with a vertical direction and the first rotary shaft A1 is positioned above the intersection region.

An angle between the first extension axis L1 and the second extension axis L2 may correspond to an angle between the third extension axis L3 and the fourth extension axis L4.

An angle between the second extension axis L2 and the third extension axis L3 may correspond to an angle between the first extension axis L1 and the fourth extension axis L4.

The power generating member may be fixedly coupled to the fourth connection link.

The first connection link may have a recessed region recessed inward, a part of the second connection link may be inserted into the recessed region, and the second rotary shaft A2 may be provided in the recessed region.

The second connection link may include: a second-first link region at least partially inserted into the recessed region and configured such that the second rotary shaft A2 is coupled to the second-first link region; a second-second link region bent from the second-first link region and extending in one direction; and a second-third link region bent from the second-second link region and extending in one direction, and the third rotary shaft A3 may be coupled to the second-third link region.

The third connection link may include: a third-first link region provided to face one side of the second-third link region and coupled to the third rotary shaft A3; a third-second link region bent from the third-first link region and extending in one direction; and a third-third link region bent from the third-second link region, extending in one direction, provided to face the second-third link region and the other side, and coupled to the third rotary shaft A3.

The third connection link may further include a third-fourth connection link bent from the third-third link region, extending in one direction, and coupled to the fourth rotary shaft A4, and the third-fourth connection link may include a portion extending downward when the device is disposed so that the first rotary shaft A1 and the first extension axis L1 are provided in parallel with a vertical direction and the first rotary shaft A1 is positioned above the intersection region.

Embodiments provide an apparatus including: a device provided to be fixed to a lateral side of a wearer's knee, in which the device includes: a power generating member configured to rotate a first rotary shaft A1; a first connection link coupled to be rotatable about the first rotary shaft A1; a second connection link coupled to be rotatable relative to the first connection link about a second rotary shaft A2 spaced apart from the first rotary shaft A1; a third connection link coupled to be rotatable relative to the second connection link about a third rotary shaft A3 spaced apart from the second rotary shaft A2; and a fourth connection link coupled to be rotatable relative to the third connection link about a fourth rotary shaft A4 spaced apart from the third rotary shaft A3, in which a first extension axis L1 defined by extending the first rotary shaft A1 in a longitudinal direction thereof, a second extension axis L2 defined by extending the second rotary shaft A2 in a longitudinal direction thereof, a third extension axis L3 defined by extending the third rotary shaft A3 in a longitudinal direction thereof, and a fourth extension axis L4 defined by extending the fourth rotary shaft A4 in a longitudinal direction thereof intersect in one region (hereinafter, referred to as an ‘intersection region’), in which the third connection link is fixed relative to the wearer's calf while facing a lateral side of the wearer's calf, and in which the fourth connection link is fixed relative to the wearer's thigh while facing a lateral side of the wearer's thigh.

When the wearer wears the apparatus, the second rotary shaft A2 may be inclined to be adjacent to the wearer in a direction toward an upper region.

When the wearer wears the apparatus, the second rotary shaft A2 may be inclined rearward in the direction toward the upper region.

When the wearer wears the apparatus, the third rotary shaft A3 may be inclined to be distant from the wearer in a direction toward an upper region.

When the wearer wears the apparatus, the third rotary shaft A3 may be inclined forward in the direction toward the upper region.

When the wearer wears the apparatus, the fourth rotary shaft A4 may be inclined to be distant from the wearer in a direction toward an upper region.

According to the present disclosure, it is possible to provide the knee-assisting apparatus, in which the new type of device capable of being applied to the apparatus 1s applied, thereby reducing a load applied to a person who wears the apparatus, improving wearing comfort, and implementing a compact structure.

### BRIEF DESCRIPTION OF THE DRAWINGS

FIG. 1 is a view illustrating a state in which a wearer wears an apparatus according to the present disclosure.

FIG. 2 is a view illustrating a device provided in the apparatus according to the present disclosure.

FIG. 3 is an enlarged view of the device provided in the apparatus according to the present disclosure when viewed at a first position.

FIG. 4 is an enlarged view of the device provided in the apparatus according to the present disclosure when viewed at a second position.

FIG. 5 is an enlarged view of the device provided in the apparatus according to the present disclosure when viewed at a third position.

FIG. 6 is a view conceptually illustrating a coupling relationship between components of the device provided in the apparatus according to the present disclosure.

### DETAILED DESCRIPTION OF ILLUSTRATIVE EMBODIMENTS

Hereinafter, an apparatus for exoskeleton robot and a device for joint structure according to the present disclosure will be described with reference to the drawings.

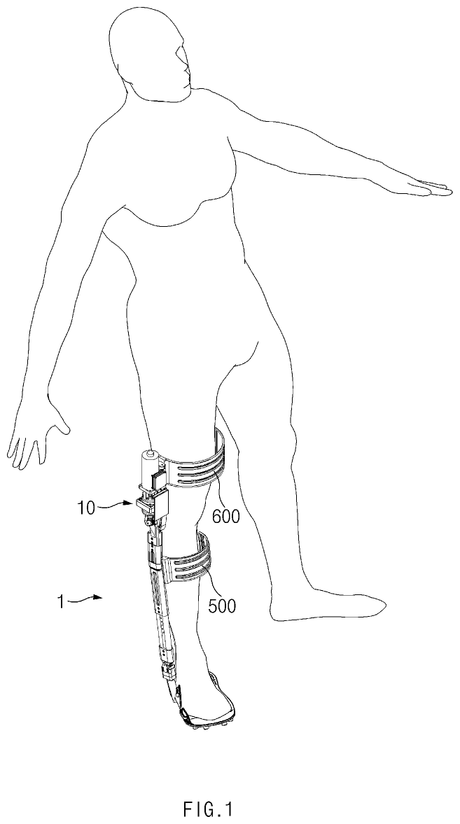

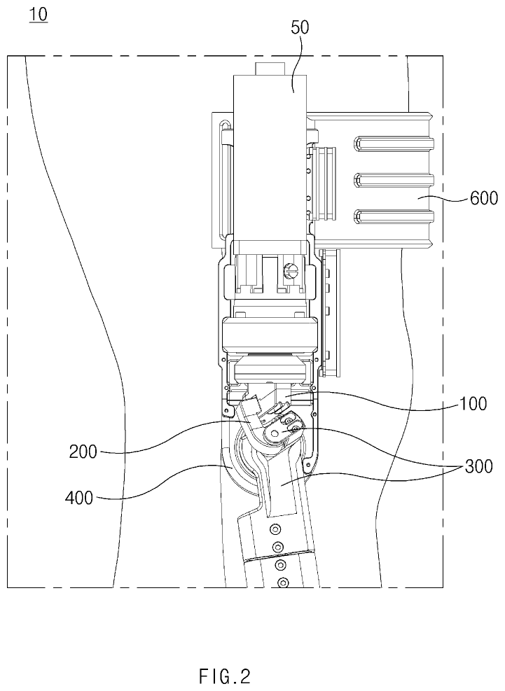

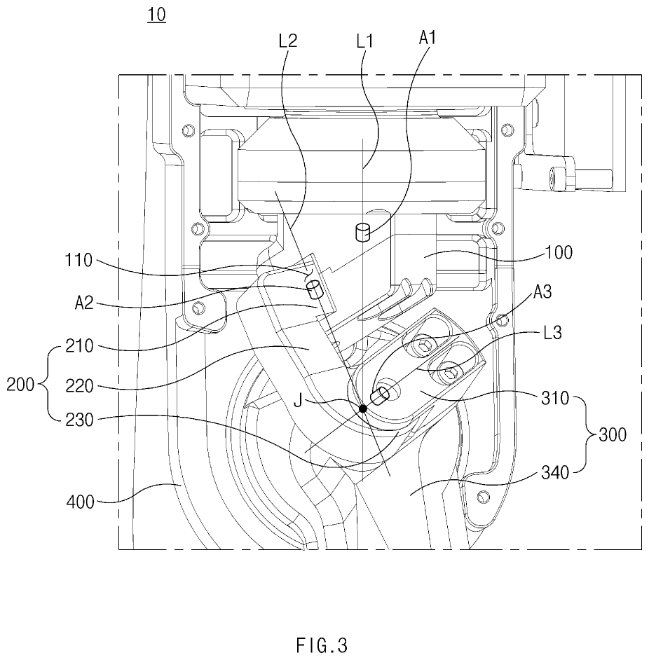

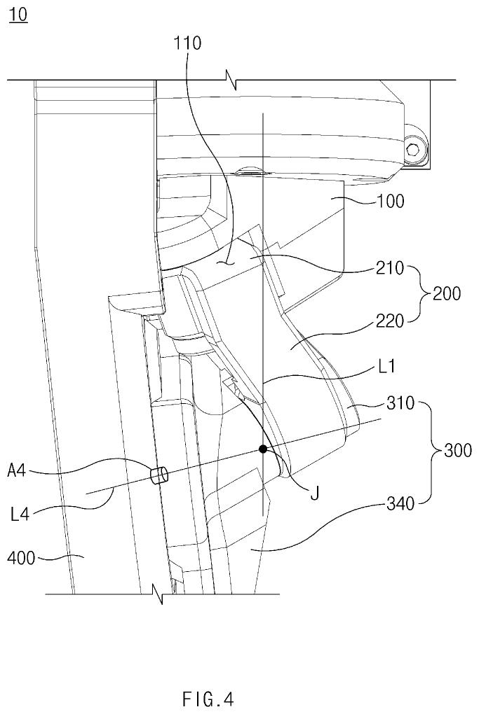

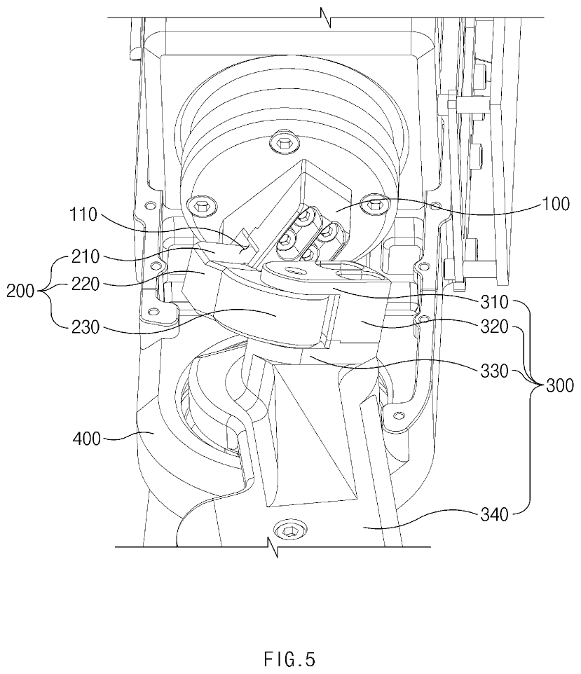

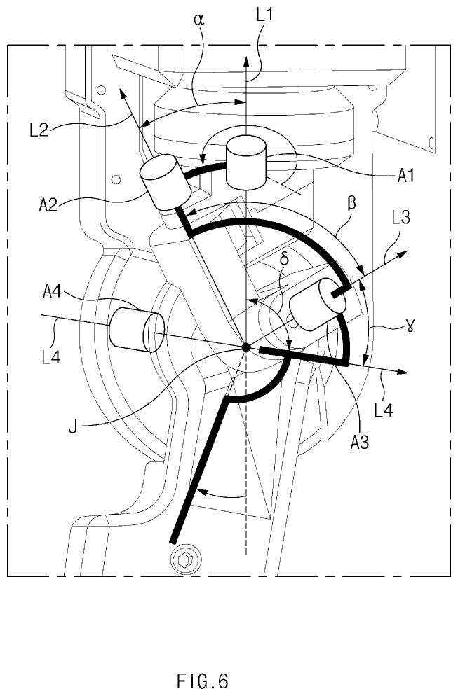

FIG. 1 is a view illustrating a state in which a wearer wears an apparatus for exoskeleton robot according to the present disclosure, and FIG. 2 is a view illustrating a device for joint structure provided in the apparatus for exoskeleton robot according to the present disclosure. FIG. 3 is an enlarged view of the device for joint structure provided in the apparatus for exoskeleton robot according to the present disclosure when viewed at a first position, and FIG. 4 is an enlarged view of the device for joint structure provided in the apparatus for exoskeleton robot according to the present disclosure when viewed at a second position. FIG. 5 is an enlarged view of the device for joint structure provided in the apparatus for exoskeleton robot according to the present disclosure when viewed at a third position, and FIG. 6 is a view conceptually illustrating a coupling relationship between components of the device for joint structure provided in the apparatus for exoskeleton robot according to the present disclosure.

An apparatus 1 for exoskeleton robot according to the present disclosure may be a device that serves to assist a wearer's knee. More specifically, the apparatus 1 for exoskeleton robot according to the present disclosure may include a device 10 for joint structure configured to be fixed to the wearer's knee and provide a force required to rotate a knee joint when the wearer's knee joint rotates. Meanwhile, in the present specification, the apparatus 1 for exoskeleton robot and the device 10 for joint structure will be described, focusing on a state in which the wearer wears the apparatus 1 for exoskeleton robot to conform to the purpose of use of the apparatus 1 for exoskeleton robot according to the present disclosure. Therefore, the contents related to the wearer disclosed in the present specification and claims make it easy to describe the apparatus 1 for exoskeleton robot and the device 10 for joint structure, focusing on the state in which the wearer wears the apparatus 1 for exoskeleton robot and the device 10 for joint structure. However, it is noted that the wearer is not a constituent element of the exoskeleton robot or the joint structure according to the present disclosure. Meanwhile, a shape of the apparatus 1 for exoskeleton robot may vary depending on a posture of the wearer who wears the apparatus 1 for exoskeleton robot. Therefore, for the convenience of description, the following description will be focused on a state in which the wearer wears the apparatus 1 for exoskeleton robot and keeps standing upright while straightening his/her knee. Therefore, a relative positional relationship between the following components in the state in which the wearer wears the apparatus 1 for exoskeleton robot and bends his/her knee may not be applied.

The device 10 for joint structure may include a first rotary shaft A1, and a power generating member 50 configured to rotate the first rotary shaft A1. For example, the power generating member 50 may be a motor including an output shaft configured to rotate. The output shaft of the motor is dynamically connected to the first rotary shaft A1, such that a rotational force of the output shaft of the motor may be transmitted to the first rotary shaft A1. The output shaft of the motor may be connected directly to the first rotary shaft A1. Alternatively, the output shaft of the motor and the first rotary shaft A1 may be indirectly connected to each other through a power transmission member such as a gear.

The device 10 for joint structure may further include a first connection link 100 coupled to be rotatable about the first rotary shaft A1. More specifically, the first connection link 100 may be fixedly coupled to the first rotary shaft A1. Therefore, when the power generating member 50 operates, the first connection link 100 fixedly coupled to the first rotary shaft A1 may rotate about the first rotary shaft A1.

In addition, the device 10 for joint structure may further include a second rotary shaft A2 spaced apart from the first rotary shaft A1, and a second connection link 200 coupled to be rotatable about the second rotary shaft A2 relative to the first connection link 100. For example, the second connection link 200 may be fixedly coupled to the second rotary shaft A2. Therefore, the second connection link 200 fixedly coupled to the second rotary shaft A2 may rotate about the second rotary shaft A2.

The device 10 for joint structure may further include a third rotary shaft A3 spaced apart from the first rotary shaft A1 and the second rotary shaft A2, and a third connection link coupled to be rotatable about the third rotary shaft A3 relative to the second connection link 200. For example, the third connection link 300 may be fixedly coupled to the third rotary shaft A3. Therefore, the third connection link 300 fixedly coupled to the third rotary shaft A3 may rotate about the third rotary shaft A3.

In addition, the device 10 for joint structure may further include a fourth rotary shaft A4 spaced apart from the first to third rotary shafts A1, A2, and A3, and a fourth connection link 400 coupled to be rotatable about the fourth rotary shaft A4 relative to the third connection link 300. For example, the fourth connection link 400 may be fixedly coupled to the fourth rotary shaft A4. Therefore, the fourth connection link 400 fixedly coupled to the fourth rotary shaft A4 may rotate about the fourth rotary shaft A4.

More specifically, according to the present disclosure, when the wearer wears the apparatus 1 for exoskeleton robot, the third connection link 300 may be fixed relative to the wearer's calf while facing a lateral side of the wearer's calf, and the fourth connection link 400 may be fixed relative to the wearer's thigh while facing a lateral side of the wearer's thigh. Therefore, the rotational motion of the wearer's knee joint may be assisted by the rotational motions of the third and fourth connection links 300 and 400 about the fourth rotary shaft A4 when the power generating member 50 operates. To this end, when the wearer wears the apparatus 1 for exoskeleton robot, the fourth rotary shaft A4 and the rotation axis of the knee joint may be disposed in parallel with each other.

Meanwhile, the first to fourth connection links 100, 200, 300, and 400 may move integrally. The configuration in which the first to fourth connection links 100, 200, 300, and 400 move integrally does not mean only a case in which the connection link is integrally configured. However, this configuration may be interpreted as including a case in which the connection link includes a plurality of components, and the plurality of components constituting the connection link is coupled to be fixed relative to one another.

Referring to the above-mentioned contents, the first to fourth connection links 100, 200, 300, and 400 are provided to be rotatable relative to one another, and thus the device 10 for joint structure may be understood as having a predetermined linkage structure. More specifically, the device 10 for joint structure according to the present disclosure may have a spherical linkage structure. The spherical linkage structure may be understood as having a structure in which extension axis lines defined by extending the rotary shafts of the links constituting the linkage structure meet together at a single point. The extension axis lines are used for illustrating and describing the embodiments of the present disclosure, but they are not a physical structure on the device 10 for joint structure.

More specifically, according to the present disclosure, a first extension axis L1 defined by extending the first rotary shaft A1 in a longitudinal direction thereof, a second extension axis L2 defined by extending the second rotary shaft A2 in a longitudinal direction thereof, a third extension axis L3 defined by extending the third rotary shaft A3 in a longitudinal direction thereof, and a fourth extension axis L4 defined by extending the fourth rotary shaft A4 in a longitudinal direction thereof may intersect one another in one region J. In the present specification, the region in which the first to fourth extension axes L1, L2, L3, and L4 intersect is defined as an intersection region J.

Referring to the drawings, when the wearer wears the apparatus 1 for exoskeleton robot and the device 10 for joint structure according to the present disclosure, the device 10 for joint structure may be disposed such that i) the first rotary shaft A1 and the first extension axis L1 are disposed in parallel with a vertical direction, and ii) the first rotary shaft A1 is positioned above the intersection region J. In this case, as illustrated in FIGS. 2 to 5, i) the second rotary shaft A2 may be provided above the intersection region J, ii) the third rotary shaft A3 may be provided above the intersection region J, iii) the second rotary shaft A2 may be provided above the third rotary shaft A3, and iv) the fourth rotary shaft A4 may be provided below the intersection region J. The features i) to iv) may be provided to provide the assistive power corresponding to the motion of the wearer's knee by allowing the fourth rotary shaft A4 to be disposed in parallel with the rotation axis of the wearer's knee joint when the wearer wears the apparatus 1 for exoskeleton robot.

In addition, according to the present disclosure, an angle α between the first extension axis L1 and the second extension axis L2 may correspond to an angle γ between the third extension axis L3 and the fourth extension axis L4. More particularly, the angle α and the angle γ may be substantially equal to each other. In addition, an angle β between the second extension axis L2 and the third extension axis L3 may correspond to an angle δ between the first extension axis L1 and the fourth extension axis L4. More particularly, the angle β and the angle δ may be substantially equal to each other. The features related to the magnitudes of the angles may be provided to allow a range of a rotation angle between the third connection link 300 and the fourth connection link 400 in accordance with the operation of the power generating member 50 to be 180 degrees. Meanwhile, the configuration in which the two angles are substantially equal to each other does not mean only a case in which the numerical values of the two angles are completely equal to each other. However, this configuration needs to be interpreted as including a case in which even though the two angles are somewhat different from each other, a difference between the two angles is small to the extent that the case in which the two angles are different from each other may exhibit substantially the same operational effect as the case in which the two angles are equal to each other based on those skilled in the technical field to which the present disclosure pertains.

Referring to FIG. 2, the power generating member 50 may be fixedly coupled to the fourth connection link 400. Therefore, like the fourth connection link 400, the power generating member 50 may also be fixed relative to the wearer's thigh. More specifically, when the wearer wears the apparatus 1 for exoskeleton robot, the power generating member 50 may be coupled to an upper region of the fourth connection link 400 so as to be adjacent to the wearer's hip joint. Therefore, the power generating member 50 may reduce a load applied to the wearer's hip joint when the wearer wears the apparatus 1 for exoskeleton robot and walks. Hereinafter, the shapes and coupling structures of the first to fourth connection links 100, 200, 300, and 400 will be described in detail with reference to the drawings.

As described above, the first to fourth extension axes L1, L2, L3, and L4 may be provided to pass through the intersection region J. In this case, when distances between the intersection region J and the first to fourth rotary shafts A1, A2, A3, and A4 increase, volumes of the connection links 100, 200, 300, and 400 also increase. In this case, it is significantly difficult to manage tolerance of the connection links 100, 200, 300, and 400, and it is difficult to manufacture the device 10 for joint structure so that the first to fourth extension axes L1, L2, L3, and L4 pass through one region, i.e., the intersection region J in common. Therefore, to make it easy to manufacture the device 10 for joint structure so that the first to fourth extension axes L1, L2, L3, and L4 pass through one region, i.e., the intersection region J in common, it may be advantageous to design the device 10 for joint structure to minimize the distances between the intersection region J and the first to fourth rotary shafts A1, A2, A3, and A4 by reducing the sizes of the connection links 100, 200, 300, and 400.

To achieve the above-mentioned object, the first connection link 100 may have a recessed region no recessed inward, a part of the second connection link 200 may be inserted into the recessed region 110, and the second rotary shaft A2 may be provided in the recessed region 110. That is, the second connection link 200 may be coupled to be rotatable in the recessed region no relative to the first connection link 100. For example, the recessed region no may have a hole shape formed through the first connection link 100.

Furthermore, the second connection link 200 may be divided into a plurality of regions. More specifically, the second connection link 200 may include: a second-first link region 210 at least partially inserted into the recessed region 110 of the first connection link 100 and configured such that the second rotary shaft A2 is inserted and coupled into the second-first link region 210; a second-second link region 220 bent from the second-first link region 210 and extending in one direction; and a second-third link region 230 bent from the second-second link region 220 and extending in one direction. In this case, the third rotary shaft A3 may be inserted and coupled into the second-third link region 230. Therefore, the third connection link may be coupled to be rotatable in the second-third link region 230 relative to the second connection link 200. More specifically, as illustrated in FIGS. 3 to 5, the second connection link 200 may have an approximately U shape.

Meanwhile, similar to the second connection link 200, the third connection link 300 may also be divided into a plurality of regions. More specifically, the third connection link 300 may include: a third-first link region 310 provided to face one side of the second-third link region 230 and configured such that the third rotary shaft A3 is inserted and coupled into the third-first link region 31o; a third-second link region 320 bent from the third-first link region 310 and extending in one direction; and a third-third link region 330 bent from the third-second link region 320, extending in one direction, provided to face the other side of the second-third link region 230, and configured such that the third rotary shaft A3 is inserted and coupled into the third-third link region 33o. More particularly, the third-first link region 310, the third-second link region 320, and the third-third link region 330 may define an approximately U shape. The U-shaped structure defined by the third-first link region 310, the third-second link region 320, and the third-third link region 330 may be provided to surround the second-third connection link 230.

Furthermore, the third connection link 300 may further include a third-fourth link region 340 bent from the third-third link region 33o, extending in one direction, and configured such that the fourth rotary shaft A4 is inserted and coupled into the third-fourth link region 34o. Therefore, the fourth connection link 400 may be coupled to be rotatable in the third-fourth link region 340 relative to the third connection link 300.

In this case, according to the present disclosure, the third-fourth link region 340 may include a portion extending downward when the wearer wears the apparatus 1 for exoskeleton robot to conform to the purpose of use of the apparatus 1 for exoskeleton robot, i.e., when the device 10 for joint structure is disposed so that the first rotary shaft A1 and the first extension axis L1 are provided in parallel with the vertical direction and the first rotary shaft A1 is positioned above the intersection region J. More specifically, the third-fourth link region 340 may be fixed relative to the wearer's calf while facing the lateral side of the wearer's calf.

Meanwhile, when the wearer wears the apparatus 1 for exoskeleton robot according to the present disclosure, the second to fourth rotary shafts A2, A3, and A4 may be inclined at a predetermined angle with respect to the vertical direction, unlike the first rotary shaft A1.

More specifically, when the wearer wears the apparatus 1 for exoskeleton robot according to the present disclosure, the second rotary shaft A2 may be inclined to be adjacent to the wearer in a direction toward the upper region and inclined rearward in the direction toward the upper region.

In addition, when the wearer wears the apparatus 1 for exoskeleton robot according to the present disclosure, the third rotary shaft A3 may be inclined to be distant from the wearer in the direction toward the upper region and inclined forward in the direction toward the upper region.

In addition, when the wearer wears the apparatus 1 for exoskeleton robot according to the present disclosure, the fourth rotary shaft A4 may be inclined to be distant from the wearer in the direction toward the upper region.

Meanwhile, as illustrated in FIG. 1, the apparatus 1 for exoskeleton robot may further include a lower close-contact member 500 coupled to one side of the third connection link 300 and provided to be in close contact with the wearer's shin, and an upper close-contact member 600 coupled to one side of the fourth connection link 400 and provided to be in close contact with the wearer's thigh. The lower close-contact member 500 may be configured to fix the third connection link 300 relative to the wearer's calf, and the upper close-contact member 600 may be configured to fix the fourth connection link 400 relative to the wearer's thigh.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A device comprising:
a power generator configured to rotate a first rotary shaft;
a first connection link coupled to be rotatable about the first rotary shaft;
a second connection link coupled to be rotatable relative to the first connection link about a second rotary shaft spaced apart from the first rotary shaft;
a third connection link coupled to be rotatable relative to the second connection link about a third rotary shaft spaced apart from the second rotary shaft; and
a fourth connection link coupled to be rotatable relative to the third connection link about a fourth rotary shaft spaced apart from the third rotary shaft,
wherein a first extension axis defined by extending the first rotary shaft in a longitudinal direction thereof, a second extension axis defined by extending the second rotary shaft in a longitudinal direction thereof, a third extension axis defined by extending the third rotary shaft in a longitudinal direction thereof, and a fourth extension axis defined by extending the fourth rotary shaft in a longitudinal direction thereof intersect in an intersection region.

2. The device of claim 1, wherein the second rotary shaft is above the intersection region when the device is disposed so that the first rotary shaft and the first extension axis are in parallel with a vertical direction and the first rotary shaft is positioned above the intersection region.

3. The device of claim 1, wherein the third rotary shaft is above the intersection region when the device is disposed so that the first rotary shaft and the first extension axis are in parallel with a vertical direction and the first rotary shaft is positioned above the intersection region.

4. The device of claim 1, wherein the second rotary shaft is above the third rotary shaft when the device is disposed so that the first rotary shaft and the first extension axis are in parallel with a vertical direction and the first rotary shaft is positioned above the intersection region.

5. The device of claim 1, wherein the fourth rotary shaft is below the intersection region when the device is disposed so that the first rotary shaft and the first extension axis are in parallel with a vertical direction and the first rotary shaft is positioned above the intersection region.

6. The device of claim 1, wherein an angle between the first extension axis and the second extension axis corresponds to an angle between the third extension axis and the fourth extension axis.

7. The device of claim 1, wherein an angle between the second extension axis and the third extension axis corresponds to an angle between the first extension axis and the fourth extension axis.

8. The device of claim 1, wherein the power generator is fixedly coupled to the fourth connection link.

9. The device of claim 1, wherein the first connection link has a recessed region recessed inward, a part of the second connection link is inserted into the recessed region, and the second rotary shaft is in the recessed region.

10. The device of claim 9, wherein the second connection link comprises:
a second-first link region at least partially inserted into the recessed region and configured such that the second rotary shaft is coupled to the second-first link region;
a second-second link region bent from the second-first link region and extending in one direction; and
a second-third link region bent from the second-second link region and extending in one direction, the third rotary shaft being coupled to the second-third link region.

11. The device of claim 10, wherein the third connection link comprises:
a third-first link region provided to face one side of the second-third link region and coupled to the third rotary shaft;
a third-second link region bent from the third-first link region and extending in one direction; and
a third-third link region bent from the third-second link region extending in one direction to face the second-third link region and the other side, the third-third link region being coupled to the third rotary shaft.

12. The device of claim 11, wherein the third connection link further comprises a third-fourth connection link bent from the third-third link region, extending in one direction, and coupled to the fourth rotary shaft, and
wherein the third-fourth connection link comprises a portion extending downward when the device is disposed so that the first rotary shaft and the first extension axis L1 are provided in parallel with a vertical direction and the first rotary shaft is positioned above the intersection region.

13. An apparatus comprising:
a device configured to be fixed to a lateral side of a wearer's knee, wherein the device comprises:
a power generating member configured to rotate a first rotary shaft;
a first connection link coupled to be rotatable about the first rotary shaft;
a second connection link coupled to be rotatable relative to the first connection link about a second rotary shaft spaced apart from the first rotary shaft;
a third connection link coupled to be rotatable relative to the second connection link about a third rotary shaft spaced apart from the second rotary shaft; and
a fourth connection link coupled to be rotatable relative to the third connection link about a fourth rotary shaft spaced apart from the third rotary shaft,
wherein a first extension axis defined by extending the first rotary shaft A1 in a longitudinal direction thereof, a second extension axis defined by extending the second rotary shaft in a longitudinal direction thereof, a third extension axis defined by extending the third rotary shaft in a longitudinal direction thereof, and a fourth extension axis defined by extending the fourth rotary shaft in a longitudinal direction thereof intersect in an intersecting region,
wherein the third connection link is fixed relative to the wearer's calf while facing a lateral side of the wearer's calf, and
wherein the fourth connection link is fixed relative to the wearer's thigh while facing a lateral side of the wearer's thigh.

14. The apparatus of claim 13, wherein when the wearer wears the apparatus, the second rotary shaft is inclined to be adjacent to the wearer in a direction toward an upper region.

15. The apparatus of claim 14, wherein when the wearer wears the apparatus, the second rotary shaft is inclined rearward in the direction toward the upper region.

16. The apparatus of claim 13, wherein when the wearer wears the apparatus, the third rotary shaft is inclined to be distant from the wearer in a direction toward an upper region.

17. The apparatus of claim 16, wherein when the wearer wears the apparatus, the third rotary shaft is inclined forward in the direction toward the upper region.

18. The apparatus of claim 13, wherein when the wearer wears the apparatus, the fourth rotary shaft is inclined to be distant from the wearer in a direction toward an upper region.
